(19) United States
(12) Patent Application Publication
(10) Pub. No.: US 2011/0071750 A1
(43) Pub. Date: Mar. 24, 2011

(54) Airport Surface Conflict Detection

(75) Inventors: Jeffrey D. GIOVINO, Melbourne, FL (US); Jonathan Schwartz, Melbourne, FL (US)

(73) Assignee: The MITRE Corporation, McLean, VA (US)

(21) Appl. No.: 12/886,097

(22) Filed: Sep. 20, 2010

Related U.S. Application Data
(60) Provisional application No. 61/244,243, filed on Sep. 21, 2009.

(51) Int. Cl. G08G 5/06; G05D 1/00; G06F 19/00

(52) U.S. Cl. 701/120

(57) ABSTRACT

Method, system, and computer program product embodiments for conflict detection of vehicles, including aircraft, are presented. According to an embodiment, a method for conflict detection of an aircraft, comprises: reducing one or more vehicle travel paths in a three dimensional space to a first dimension; receiving data corresponding to a motion of the aircraft; mapping the motion to the one or more vehicle travel paths in the first dimension; and transmitting an alert if a potential conflict is determined in the one or more vehicle travel paths in the first dimension. Corresponding system embodiments and computer program product embodiments are also disclosed.

### CROSS REFERENCE TO RELATED APPLICATIONS

This application claims the benefit of U.S. provisional application No. 61/244,243, filed on Sep. 21, 2009, which is hereby incorporated by reference in its entirety.

### STATEMENT REGARDING FEDERALLY SPONSORED RESEARCH AND DEVELOPMENT

This invention was made with government support under DTFA 01-01-C-00001 awarded by the Federal Aviation Administration. The government has certain rights in the invention.

### BACKGROUND OF THE INVENTION

1. Field of the Invention

The present invention relates generally to conflict detection involving multiple vehicles, and particularly to conflicts involving aircraft.

2. Background

Reducing the occurrence of runway incursions and conflicts has become a focus of the aviation safety community. Runway incursions and conflicts can occur, for example, when a second aircraft, another vehicle, or some other entity intrudes into an area which is already cleared for use by a first aircraft. Such incursions and conflicts can potentially lead to collisions and/or near collisions.

A substantial number of the runway incursions involve a second aircraft entering a runway ahead of a first aircraft departing or landing. Human error appears to be a substantial contributor to runway incursions. Contributing factors include errors made due to airport markings, incorrectly understood directions from the control tower to the aircraft crew, lighting in runway areas, and pilots lack of familiarity with particular airport environments. An approach to reducing runway conflicts is to generate alerts so that the crew of one or both of the vehicles involved, and/or the control tower crew can take appropriate action to avert the potential conflict.

Reliable and efficient methods and systems are therefore desired for aircraft conflict detection and alerting.

### SUMMARY OF THE INVENTION

Method, system, and computer program product embodiments for conflict detection of vehicles, including aircraft, are presented. According to an embodiment, a method for conflict detection of an aircraft, comprises: reducing one or more vehicle travel paths in a three dimensional space to a first dimension; receiving data corresponding to a motion of the aircraft; mapping the motion to the one or more vehicle travel paths in the first dimension; and transmitting an alert if a potential conflict is determined in the one or more vehicle travel paths in the first dimension.

Another embodiment is a system for conflict detection of aircraft. The system comprises at least one processor, at least one memory coupled to the processor, an aircraft motion data receiving module, a one dimensional reducer module, a vehicle motion mapper, and a conflict detector. The aircraft motion data receiving module can be configured to receive data corresponding to a motion of the aircraft. The one dimensional reducer module can be configured to reduce one or more vehicle travel paths in a geographic area to a first dimension. The vehicle motion mapper can be configured to map the motion to the one or more vehicle travel paths in the first dimension. The conflict detector can be configured to transmit an alert if a potential conflict is determined in the one or more vehicle travel paths in the first dimension.

Yet another embodiment is a computer readable media storing instructions wherein the instructions when executed are adapted to detect a conflict of an aircraft with a method. The method includes reducing one or more vehicle travel paths in a geographic area to a first dimension; receiving data corresponding to a motion of the aircraft; mapping the motion to the one or more vehicle travel paths in the first dimension; and transmitting an alert if a potential conflict is determined in the one or more vehicle travel paths in the first dimension.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

FIG. 1 is a flowchart for a method to detect aircraft conflicts, according to an embodiment of the present invention.

FIG. 2 is a flowchart of a method to create an abstraction of the vehicle travel paths, according to an embodiment of the present invention.

FIG. 3 illustrates an airport surface comprising runways and taxiways in the form of a surface abstraction map, and a superimposed linked decision tree along centerlines and vertices, according to an embodiment of the present invention.

FIG. 4 is a flowchart of a method for mapping vehicle location and motion to an abstracted representation of the vehicle travel paths, according to an embodiment of the present invention.

FIG. 5 is a flowchart of a method for generating an alert for a detected conflict, according to an embodiment of the present invention.

FIG. 6 is a flowchart of a method for detecting conflicts, according to an embodiment of the present invention.

FIG. 7 is a flowchart of a method for detecting common runway conflicts, according to an embodiment of the present invention.

FIG. 8 is a flowchart of a method for detecting intersecting runway conflicts, according to an embodiment of the present invention.

FIG. 9 illustrates vertex lists for a first and second aircraft, and the determination of times at which each aircraft will be in common vertices, according to an embodiment of the present invention.

FIG. 10 is an aircraft conflict detection system, according to an embodiment of the present invention.

FIG. 11 illustrates an aircraft conflict detection system, according to an embodiment of the present invention.

FIGS. 12a and 12b illustrate further details of the aircraft conflict detection system of FIG. 11, according to an embodiment of the present invention.

FIG. 13 illustrates a computer system, according to an embodiment of the present invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

The present invention relates to predicting conflicts (e.g., collisions) of vehicles including, but not limited to, aircraft. More particularly, the present invention enables the prediction of potential conflicts and the generation of alerts ahead of such conflicts. Embodiments of the present invention can be used, for example, to predict potential conflicts and provide warnings to allow pilot actions or control tower actions that would avoid conflicts between two aircraft on runways and/or taxiways in airports. Embodiments of the present invention can be utilized, for example, on board aircraft as part of the cockpit display and equipment, in other ground vehicles traveling on airport runways and taxiways, or as part of traffic control operations of the airport.

The generation alerts for potential conflicts of aircraft and other vehicles on an airport's surface (generally referred to as surface alerting) such as runways and taxiways are complicated by the presence of surveillance errors and radio frequency (RF) reception loss in the environment. The detection of aircraft and other vehicles (e.g., ground vehicles on airport runways and taxiways) in relation to an airport's surface involves three dimensions, i.e., the two dimensions of the airport surface and the vertical dimension to detect aircraft approaching to land on the airport surface.

Conventional solutions approach the problem as a three-dimensional problem and use legacy three-dimensional surveillance techniques. Conventional solutions to this problem, however, are inadequate to resolve the complications caused due to the airport environment such as surveillance errors and RF reception degradation.

The present invention is a novel approach that can be used to resolve potential vehicle conflicts on airport surfaces. Instead of attempting to solve the problem in all three dimensions, an embodiment of the present invention reduces the solution space to one-dimensional centerlines thereby effectively removing many of the system dynamics as variables. Having abstracted the solution space to a single dimension, tools are configured to use closed form equations to predict surface conflicts and to generate alerts. The timely generation of such alerts can enable the pilots of the aircraft, drivers or ground vehicles, airport traffic control personnel, or other persons or systems to initiate preventive action.

Embodiments of the present invention addresses two classes of potential conflicts or collisions:
conflicts when two aircraft or vehicles move along intersecting runways or taxiways (“intersecting runway collisions”); and
conflicts when two aircraft or vehicles move along or are intended for the same runway or taxiway (“common runway collisions”).

These two types of conflicts are different from each other because intersecting runway or taxiway collisions can only occur in an intersection, while common runway collisions can happen anywhere along the respective runway or taxiway. Without loss of generality, the term conflict is used to refer to both classes of potential conflicts or collisions.

The airport surface, according to embodiments of the present invention, include runways and taxiways. As used herein, a runway is a strip of airport surface designed for aircraft to take off from and land on and forms part of the maneuvering area. A taxiway is a path on an airport surface connecting runways with ramps, hangars, terminals and other facilities. When on the ground, aircraft are generally restricted to movement on runways and taxiways. Generally, both runways and taxiways have centerlines marked therein. It is assumed that aircraft movement is substantially along the respective centerlines of the runways and taxiways. For ease of description in the following, the term “runway” is used to encompass runways and taxiways.

The layout of airports and the motion of aircraft and other vehicles on an airport surface can be complex. Therefore, in embodiments of the present invention, a “surface abstraction map” is created for each airport. The surface abstraction map is created by determining three-dimensional centerline data as multiple centerline segments with a given traveled length (e.g., distance between endpoints), and then combining those centerline segments into a linked decision tree such as a Bayesian network. Each straight segment of a runway can be modeled as a single centerline segment, while each turning runway and each branching runway can be modeled as one or more centerline segments as appropriate. In the vertical dimension, the centerline for the approaching aircraft is mapped to a corresponding runway centerline. Intersections, or more accurately the ends of each centerline, are modeled as vertices. As centerlines substantially capture the potential movement paths of vehicles and aircraft on runways as well as taxiways, the surface abstraction map represents the entire airport surface comprising runways and taxiways.

Each centerline is defined as a linear length with start and end points. The linear lengths of one or more centerlines are then used to calculate total traveled linear distance from aircraft to airport surface intersections (i.e., runway intersections). The surface abstraction map is then generated from the many smaller centerlines. This map is then traversed for potential aircraft movement on the surface. The set of all possible routes as defined by the centerlines yields a one-dimensional solution space. In an embodiment of the present invention, the method for generating the surface abstraction map from multiple centerline definitions is implemented in software. However, implementation of at least some of the method for generating the surface abstraction map in hardware is also contemplated.

Vehicles on the ground are constrained to runways and taxiways. Vehicles in the air (e.g., aircraft approaching to land) are associated with a corresponding runway. For clarity, embodiments of the present invention are described with respect to two vehicle conflicts. However, persons skilled in the art would understand that the teachings herein can also be used for conflict detection in situations involving more than two vehicles. Because vehicles are constrained to runways, their positions can be represented in one dimension by the distance from the threshold. For example, turning, intersecting, and branching centerlines can all be represented in one dimension as one or more lines between two endpoints or vertices. By representing the surface area as a set of vertices and centerlines, the predicted locations of a vehicle can be represented by a finite set of positions. This can easily be transformed to distance from the intersection by adding a value configured for the particular airport. Paths of motion and future predicted positions can be modeled as functions of time and distance from a threshold such as an intersection. Conflicts can then be modeled in time alone for a particular intersection or runway. With this approach, through the creation of a surface abstraction map and by modeling the motion and positions of vehicles as a function of time and distance, the present invention reduces the three-dimensional area of conflict to a single dimension. With respect to a particular runway or taxiway, the motion and positions of a vehicle can be expressed as a function of time only.

### Creating the Surface Abstraction Map

A software program can be used to generate the surface abstraction map. In an embodiment, a software application programming interface (API) and corresponding software engine is provided to perform the following functions:
Load airport surface data
Combine the surface data into meaningful maps
Geo-reference surveillance data to airport locations
Provide a tree of predicted possible future centerline paths

Once the surface abstraction map is created and the potential paths of aircraft of concern have been mapped, the conflict detection algorithms can be initiated.

Load airport surface data: Airport surface data can be input to the system from many sources. In one embodiment, airport surface data is loaded from preprocessed flat text file that contains a series of vertices which are each assigned a unique integer identifiers. It is contemplated that a system can automatically extract such data from maps of an airport layout. These vertices are then mapped into centerline definitions. In the context of the API, centerlines can represent any one of the following surface primitives: approach corridor, runway segment, taxiway segment, arc, hold short line, ramp, and other aircraft travel path segments. An approach corridor uses the vertices representing the thresholds of the runway. From these two vertices the actual runway heading/bearing can be calculated in both Cartesian radians and navigational degrees. The approach corridor can resemble the approach as depicted on the approach plate in the horizontal plane. Generally, it represents an abstract geometric shape similar to a fan at a 3 nautical miles and 3 degrees. The shape may be defined by predetermined values for an approach length and other parameters. This fan shape is then bounded by the statistical error of the system defined by the root sum of squares (RSS) of all the measurement errors and the defined containment. Runway segments and taxiway segments can be treated geometrically the same. Each is a segment with two vertices as endpoints and a statistical width. The statistical width of a runway can be derived by calculating the RSS of all system errors, and based on a desired containment. The statistical width can be used to determine if a surveillance report is applicable to a given runway/taxiway centerline segment. The resulting abstract geometric shape is a relatively skinny rectangle with semicircle nubs at the ends. Arcs are used to represent any surface centerline segment that is curved and has a constant radius.

Combine surface data into meaningful maps: The surface centerline segments are tested for continuity and an algorithm using linked lists, such as linked lists in which nodes can be linked to multiple other nodes, can be used to generate the surface abstraction map for the corresponding airport. In general, the surface abstraction map is created to represents all possible routes on the airport surface. Two or more criteria may be used to generate the connections: centerline segments must share a common endpoint, and the resulting (tangential) difference in heading must be less than a predetermined angle (e.g., 45 degrees)

Geo-reference surveillance data to airport locations: Because the centerlines are defined by specifying the statistical width of the segment they can overlap at endpoints and intersections. Thus, a surveillance state vector can have many solutions. The API can therefore iteratively return all centerlines that meet the conditions. This can be performed in a three phase approach. For example, a first filter can be applied to filter on an airport scale to focus on centerline segments from one airport surface at a time. A second filter can eliminate centerline segments that fall outside the predefined range constant. A third filter can then determine if each centerline segment is a candidate solution (i.e., part of the airport surface area of interest). This three phase approach is used to optimize processing for a real world installation.

Provide a tree of possible future centerline positions: Given the ability to generate a linked list map of possible routes an aircraft can take on the airport surface and the ability to determine where on that map an aircraft is, it is possible to predict where the aircraft will be in time one dimensionally. Therefore, the linear length of each segment on the route tree can be used to determine where the aircraft is likely to be in the future. Knowing the aircraft's acceleration, velocity, and position on the centerline makes this a distance and time equation. These potential future positions can be the output provided by the API.

### Conflict Detection

In an embodiment, in detecting either type of conflict (i.e., intersecting runway conflicts and common runway conflicts) the motion of vehicles can be modeled using a parabolic model as shown in Equation (1):

P=½at²+vt+P₀ (1)

Using the model as defined by equation (1) for the motion of each vehicle or aircraft, conflict detection can be performed for each type of potential conflict.

Centerline endpoints are considered as intersections. For each intersection a protection zone is defined, for example, by defining a protection zone radius measured from the center of the intersection. For intersecting runway conflicts, a conflict is determined if two aircraft are in the same intersection or protection zone within the same time interval. In some embodiments, the radius of the protection zones can be dynamically adjusted based on environmental dynamics or aircraft or vehicle dynamics such as speed. Respectively, solving for time for each vehicle or aircraft to reach a protection zone with respect to each intersection can produce a prediction as to a conflict between a first and a second vehicle or aircraft. Thus, in intersecting runway conflicts, conflict detection is performed by solving for the time of entering an intersection (tᵢₙ) and time of exit from the intersection (tₒᵤₜ) by a vehicle. Note that in the surface abstraction map the intersections are centerline endpoints or vertices.

For common runway conflicts, the approach of “minimum missed distance” can be employed and time to the missed distance can be calculated if a conflict exists on shared surface centerline segments. Thus, in common runway encounters, conflict detection is performed by determining whether the distance between two vehicles, given their predicted motion, is less than a predetermined minimum threshold. In an embodiment, the distance between two vehicles on a common runway can be determined by solving equation (1) respectively for a first and second vehicle to determine their positions.

In an embodiment of the present invention, two algorithms can be executed in parallel or in sequence to exercise the generic subset of conflict detection capabilities: common runway encounters algorithm, and intersecting runway encounters algorithm. The algorithms are described below.

### Intersecting Runway Encounters Algorithm

The intersecting runway encounter algorithm implements an approach of abstracting the motion of vehicles and aircraft to one dimension with time. Utilizing the intersecting runway encounters algorithm and the airport surface abstraction map created for a particular airport or area thereof, enables a user to treat any airport surface vertex as an intersecting point. This approach is sufficiently robust to detect a majority of potential airport surface encounters.

According to an embodiment, the intersecting runway encounters algorithm comprises the following steps:
1. Generate both the respective surface vertex lists for the first aircraft and the second for a predetermined look ahead time;
2. Find all common vertices, i.e., these are the potential intersection points;
3. Calculate time in and time out of each vertex protection zone (i.e., area within an intersection) for both the first and second aircraft;
4. For each common vertex, determine if the vertex (i.e., intersection) is occupied at the same time by both aircraft by comparing time in and out for the respective aircraft;
5. Generate a potential conflict for the first vertex that meets the criteria; and
6. Apply higher level processing to assign conflict severity levels and/or to filter false alarms.

In step 1 of the intersecting runway encounters algorithm, a function is applied to both first aircraft and second aircraft to determine where on the airport surface both aircraft are located. This may return multiple locations given reported position and system uncertainty. For example, given enough similarity between a taxiway and a runway, coupled with inaccurate surveillance data, the system may be unable to accurately determine which centerline the aircraft is currently on and therefore may return two or more possibilities. In an embodiment, all the potential starting centerlines are respectively used as origination points to walk the surface abstraction map. Walking the surface abstraction map is performed by following a centerline from one vertex in the surface abstraction map to another. In another embodiment, route prediction is used in walking the surface abstraction map. For example, heuristics such as ‘not probable for aircraft to loop back to a centerline segment in which it was previously present,’ ‘not probable to taxi off runway then back on same runway,’ ‘high probability for approaching aircraft to land on runway and low probability to land on taxiway,’ and ‘at high velocity stay on runway rather than taxiway,’ and the like can be used to prune potentially extraneous routes. In an embodiment, a set of dynamically linked pointers represent the traversal from one centerline to the next. In order to determine how far to walk the map (to determine how much motion of an aircraft needs to be explored), a walk distance for each aircraft is calculated by applying a predetermined look ahead time to a corresponding aircraft's state vector linear acceleration and ground speed. The look ahead time dictates how far into the future the system will detect potential conflicts. Expected values range from 10 to 30 seconds, but may be configured to a higher or lower value. The dynamically linked centerline segments are coupled at common vertices. Each vertex will be stored in a vertex list for the respective aircraft if the vertex is within the distanced defined previously.

In step 2 of the intersecting runway encounters algorithm, the vertex lists for the first and second aircraft are compared. It is important to treat each instance of a given vertex independently because it is possible that with a large look ahead time a walk of the surface abstraction map can loop back over the same vertex more than once. All vertices that match are added to a common vertex list. This common vertex list is the limited subset of potential conflict points.

In step 3 of the intersecting runway encounters algorithm, the distance to each vertex is calculated by accumulating the length of each subsequent centerline segment. Then the distance to both sides of a protection zone about these vertices is calculated. For example, the distance to enter the protection zone (dᵢₙ) and the distance to exit the protection zone (dₒᵤₜ) is calculated. Based on the respective distances, calculate the time in (tᵢₙ) and out (tₒᵤₜ) of each vertex for both first aircraft and second aircraft. Using a predefined protection zone to characterize the vertex simplifies the problem to a quadratic expression with constant acceleration as shown in equations (2) and (3) below.

½at²+vt−d_{(in/out)}=0 (2)

t_{(in/out)}={−v+/−sqrt(v²+2ad_{(in/out)})}/a (3)

In step 4 it is determined if first aircraft and second aircraft occupy the same protection zones at the same time. This is accomplished by comparing tᵢₙ and tₒᵤₜ for both first aircraft and second aircraft at each vertex. Let F.tᵢₙ and F.tₒᵤₜ be the first aircraft's time in and out of the protection zone and similarity let S.tᵢₙ and S.tₒᵤₜ represent the second aircraft's times in and out of the corresponding protection zone. If the first aircraft leaves the protection zone prior to the second aircraft entering, or if the second aircraft leaves the protection zone prior to first aircraft entering, then a potential conflict can be ruled out within the considered intersection:

(F.tₒᵤₜ<S.tᵢₙ) OR (S.tₒᵤₜ<F.tᵢₙ) (4)

A potential conflict can be detected using DeMorgan's law which yields:

(F.tₒᵤₜ>=Si.tᵢₙ) AND (S.tₒᵤₜ>=F.tᵢₙ) (5)

In step 5, a conflict structure for every vertex that meets the criteria is populated using the vertex position corresponding to the encounter or conflict, second aircraft, time to conflict, knowledge of airport centerline identifying information, etc. Time to conflict is the greater of the time in the protection zone for first aircraft and second aircraft.

In step 6, by applying higher level conflict logic and processing, implementers and/or users can utilize the detected conflicts to trigger an alerting system or other preventive system for conflict avoidance. Higher level conflict logic and processing can include determining a probability of conflict, determining a categorization or levels of potential conflicts, generating warnings, and the like.

### Common Runway Encounters Algorithm

The common runway encounter scenario algorithm implements an approach of abstracting the motion of vehicles and aircraft to one dimension with time. Utilizing the common runway encounters algorithm with the airport surface abstraction map enables the treatment of a centerline as a common runway. This will allow detection of potential conflicts in a one dimensional plane. As noted above, each aircraft's motion in one dimension can be characterized as in equation (1) above. Equation (1) can be solved to determine when the positions of both aircraft cross a protection zone boundary. The protection zone in the common runway instance is a zone defined relative to each aircraft. For example, the first aircraft can have its protection zone defined in terms of a distance forward and a distance to the rear to itself. In equation (1), with respect to each aircraft, a is the current acceleration based on ground speed, v is the current ground speed, and P is the current distance to the runway threshold. The common runway encounters approach is also used to capture the case where tangential flights with relatively close velocities may take several seconds to encroach and several more seconds to resolve. The common runway encounters approach also solves the chasing problem that occurs when one aircraft is landing and another is taking off.

The common runway encounters algorithm, according to an embodiment, is defined by the following steps:
1. Generate both first aircraft and second aircraft routes lists based upon possible centerline segments in a given look ahead time,
2. Build the common segment route list;
3. Calculate P₀ from the common segment start point;
4. Solve for time when |dₒ−dᵢ|=PROTECTION_ZONE, this is tᵢₙ and tₒᵤₜ of the PROTECTION_ZONE on common routes;
5. Solve for dₙₑₐᵣ and d_{far} for both first aircraft and second aircraft;
6. Test if dₙₑₐᵣ or d_{far} are contained in the common centerline segment;
7. Generate a potential conflict for the first route that meets the criteria; and
8. Apply higher level processing for assigning conflict levels or filtering of false alarms.

P₀ is the position or distance at the time of origin (see equation (1)). PROTECTION_ZONE refers to the protection zone relative to the respective aircraft. With respect to each aircraft, dₒ and dᵢ are determined based on the quadratic equation derived from equation (1) with respect to time. tᵢₙ and tₒᵤₜ represent the times when the other aircraft enters and exits the protection zone. Having solved equation (1) for time, dₙₑₐᵣ and d_{far} are determined for each aircraft by substituting the values for tᵢₙ and tₒᵤₜ in equation (1).

### Example Method Embodiments

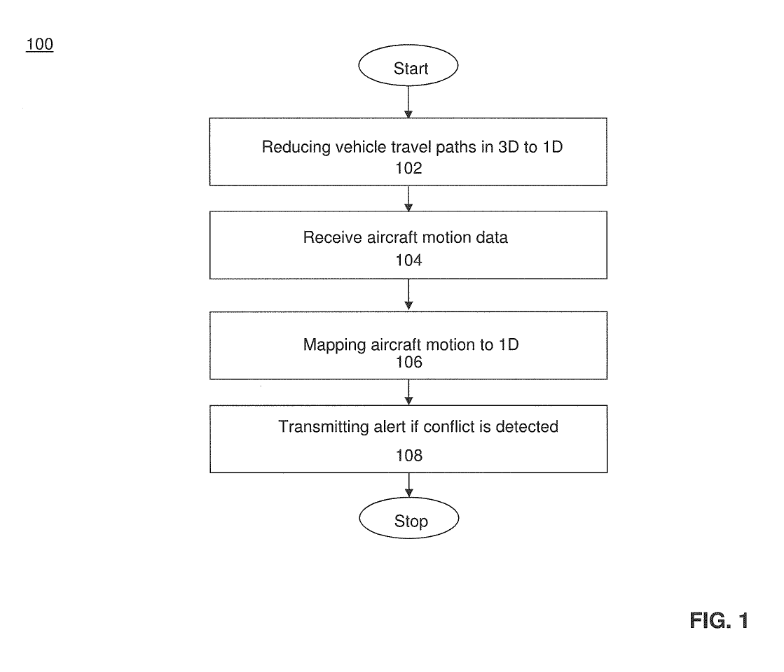

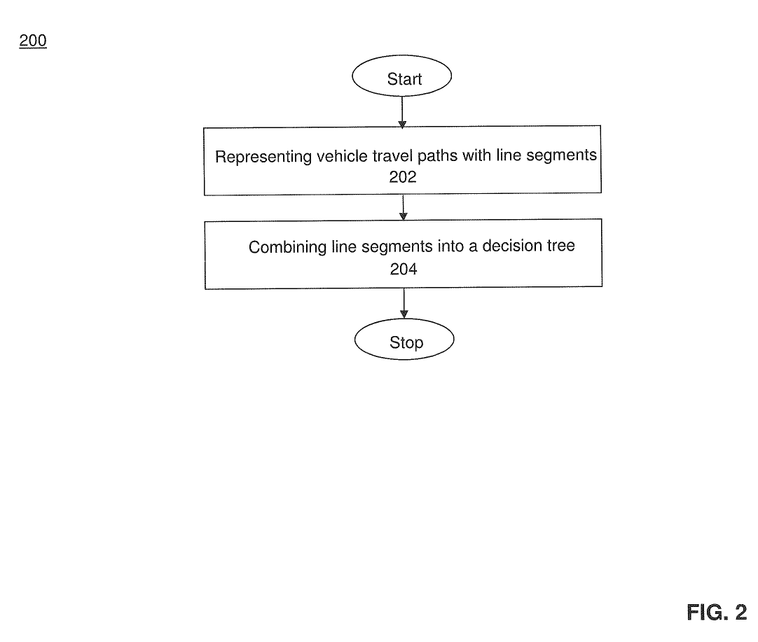

FIG. 1 illustrates a method 100 to detect aircraft conflicts, according to an embodiment of the present invention. In step 102, the available travel paths in three dimensional space are reduced to a representation in a single dimension. For example, the available travel paths are represented in a decision tree with respect to time. The created one dimensional representation of the available travel paths is referred to herein as the surface abstraction map. As described above, a separate surface abstraction map can be created for each airport or other area of interest for conflict detection. FIG. 2 illustrates further details about the reduction of the travel paths from three dimensional space to a single dimension.

In step 104, motion data of an aircraft is received. According to an embodiment, one or more of, the current location of the aircraft, the direction and speed, and projected plan of motion can be received. For example, an aircraft can continually communicate its information to a command and control system in the airport. An aircraft, for example, can communicate such information from the time it approaches to land to the time it comes to a halt at a terminal gate. The communicated data can be in any form in which the receiving module can identify the required position and motion information. Motion information can include, for example, direction, speed, and acceleration of the aircraft. According to an embodiment, the motion information can also include a destination and/or one or more intermediate destinations in the aircrafts current travel path.

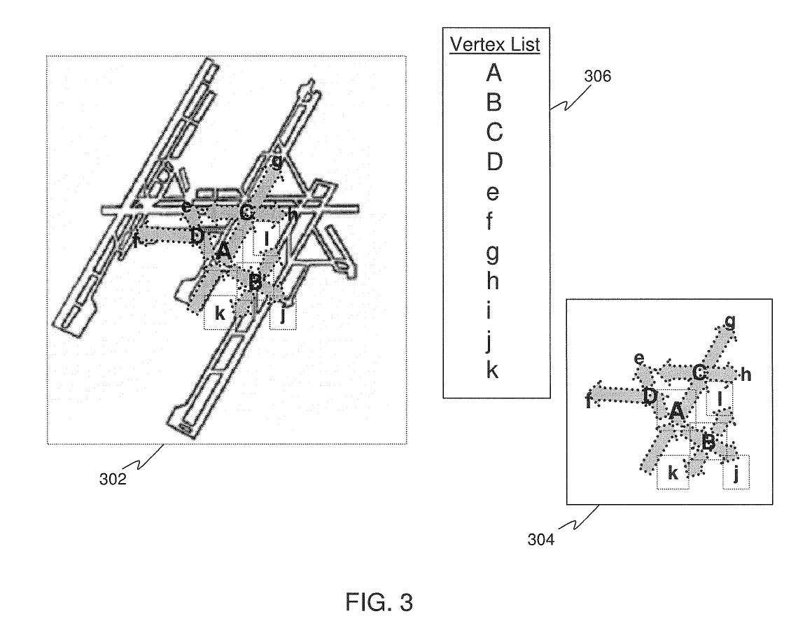

In step 106, the received aircraft motion information is mapped onto the one dimensional representation of the surface of interest. In this step, the current location of the aircraft is mapped on to the surface abstraction map, and based on the motion information potential routes of the aircraft are identified on the surface abstraction map. For example, the potential time(s) of arrivals of the aircraft in path segment and intersection in the surface abstraction map can be determined. Mapping of aircraft motion information to the surface abstraction map is further described in relation to method 300 illustrated in FIG. 3.

In step 108, if a potential conflict is detected, an alert is generated and transmitted to one or more destinations. In this step, the projected paths of the aircraft in the one dimensional surface abstraction map are compared with the projected paths of one or more other vehicles in the surface abstraction map. The comparison can reveal instances when the aircraft and one or more other vehicles are in the same path segment or intersection during the same time interval. Such instances where two or more vehicles are projected to the same area in the surface abstraction map at the same time can be detected as a potential conflict. As described above, a conflict can be a potential collision, near-collision, or an incursion of a second vehicle into a area closer than a threshold distance from the area occupied by a first aircraft. The detected conflicts can be filtered based on various heuristics and/or configured rules, so that false alarms are reduced.

The generated alert, as noted above, can be used by various entities, such as, but not limited to, pilots of aircraft, ground vehicle controllers, and air traffic control, to take steps to avoid the indicated conflicts.

FIG. 2 illustrates method 200 for reducing the travel paths in three dimensions to a single dimension. For example, method 200 can be used to generate the surface abstraction map noted above.

In step 202, the vehicle travel paths in the three dimensional space is represented in a single dimension. According to an embodiment, a surface abstraction map is created representing the vehicle travel paths in a single dimension with respect to time. For example, each route in a original travel path (i.e., a vehicle travel path in the three dimensional space) is represented using one or more line segments. Each line segment can, for example, be represented by a length and two vertices. Accordingly, a vehicle travel path of length l without any intermediate intersections can be represented by a single line segment of length l. Two or more line segments can be interconnected at their respective vertices. The vertices at which line segments interconnect represent intersections.

In step 204 the line segments are combined in a manner that the tracking of vehicle paths in a single dimension is facilitated. According to an embodiment, the line segments are connected to form a decision tree. For example, at each intersection connecting three or more line segments, probabilities can be configured for each pair of in coming and outgoing paths. The probabilities can be preconfigured (e.g., all paths have equal probability of being taken, or the shortest of the paths is taken 75% of the times), can be manually assigned to respective intersections or groups of intersections, or they can be dynamically calculated based on various factors such as type of vehicle projected to the travel the path, and the vehicle's current motion.

The decision tree enables the location of a vehicle to be represented based only on time. For example, based on the current location and the projected motions of the aircraft, the time at which the aircraft will enter an exit each vehicle travel path (represented as a line segment in the decision tree) and intersection (represented as a vertex in the decision tree).

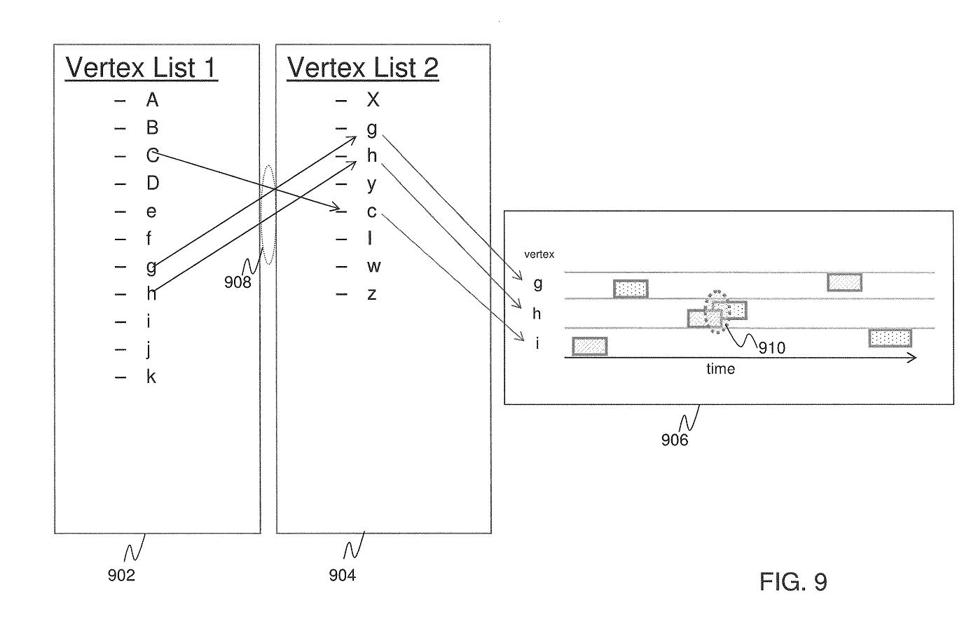

FIG. 3 illustrates an exemplary airport layout 302 and a decision tree 304 determined based on the airport layout 302. For illustrative purposes, in decision tree 304 each vertex is assigned an identifier. The illustrated portion of the decision tree 304 can, for example, represent the decision tree with respect to an aircraft arriving at intersection A. At aircraft arriving at intersection A can, according to some probability, be projected to travel down one or more of the respective paths AD, AC, and AB where AD, AC, and AB represents the paths between A and respectively D, C, and B. The list of vertices 306 from the decision tree can be used for the detection of potential conflicts, as described below with respect to FIG. 9.

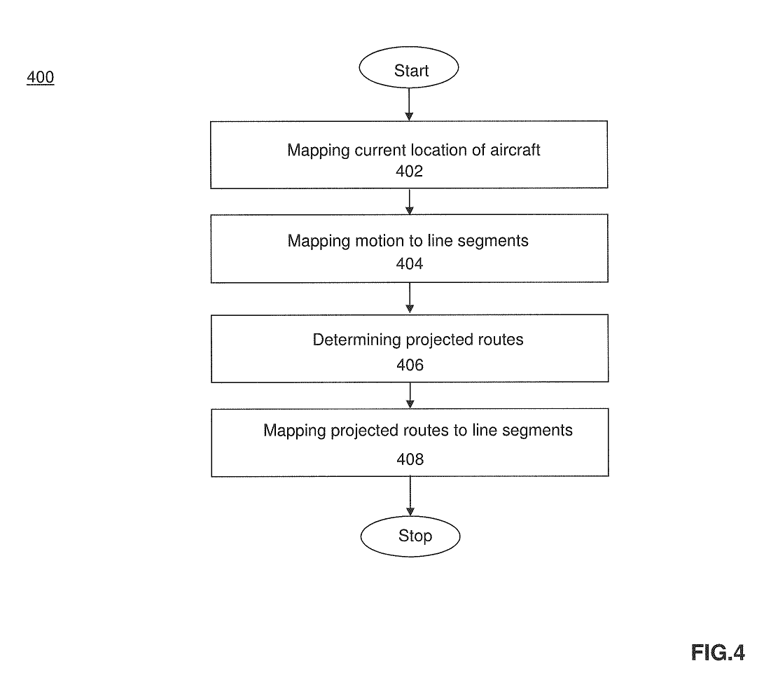

FIG. 4 illustrates a method 400 that can be used to map the vehicle motions to the one dimensional representation. According to an embodiment, method 400 is used to map the current location and projected paths of an aircraft into the surface abstraction map.

In step 402, the current location of the aircraft is determined and mapped to the surface abstraction map. According to an embodiment, the current location of the aircraft can be determined from real-time data received from the aircraft. The data can also be received from a command and control center or like source which tracks the aircraft in real-time or near real-time. The mapping of the current location to the surface abstraction map is then based on the mapping of vehicle travel paths in three dimensional space to the line segments in a single dimension.

In step 404, the motion is mapped to line segments. According to an embodiment, the direction, speed and acceleration of travel of the aircraft can be determined from the real-time data received from the aircraft. Similar to the current location of the aircraft, current motion information can be received from another source, such as a command and control center, that tracks the movements of the aircraft.

In step 406, projected routes of the aircraft are determined. According to an embodiment, projected routes are determined based on the current location and projected movements of an aircraft. For example, an aircraft coming into land may have already been assigned a specific gate at a terminal. The projected route for that aircraft would then include the route from the landing point in a runway to the assigned gate, through one or more runways and taxiways. The projected routes can be determined for a configurable look-ahead time interval.

In step 408, the projected routes are mapped to the one dimensional surface abstraction map. According to an embodiment, based on the current location, direction, and speed of movement, the time at which the aircraft enters and exits each line segment and each intersection can be determined. Based on the type of situation, one or more projected routes can be mapped to the surface abstraction map. For example, in situations where there are no alternate routes in the three dimensional space which the aircraft can follow to reach an assigned gate, it suffices to only map the single projected route to reach the assigned gate. However, where alternate routes are possible, projected routes can be mapped for at least some of the projected paths in order to provide a more reliable conflict detection and alerting service.

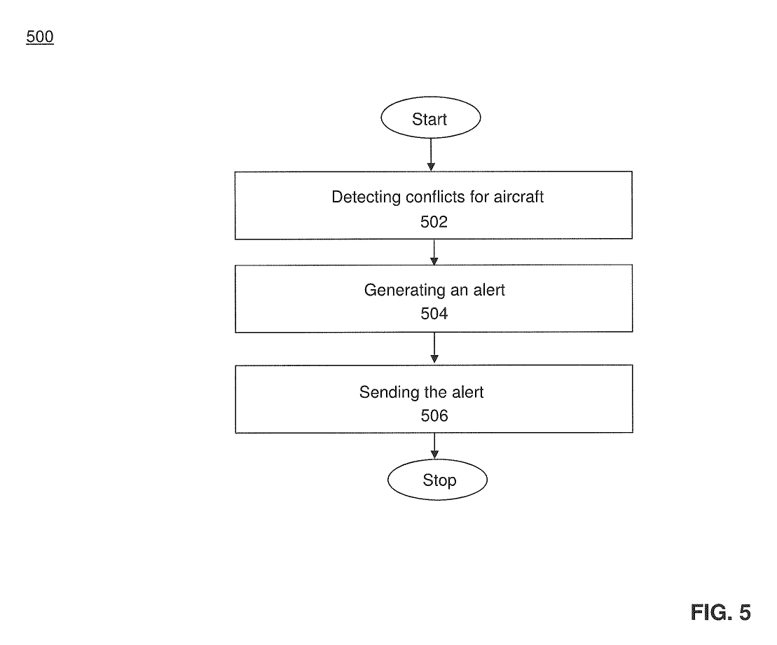

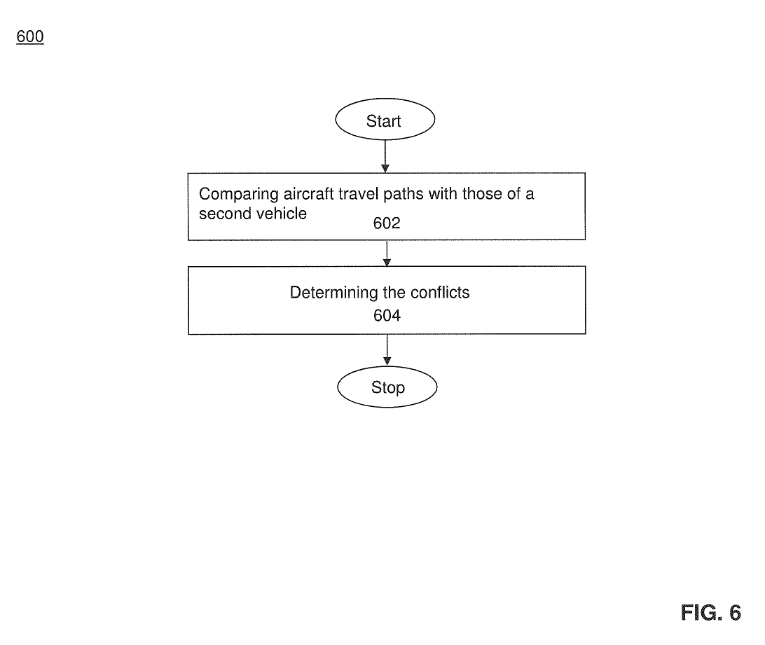

FIG. 5 illustrates a method 500 to detect conflicts and transmit a corresponding alert. In step 502, a conflict is detected. According to an embodiment, the detection of conflicts is based on comparing the projected routes of an aircraft with the projected routes of one or more other vehicles, as those projected routes are represented in the surface abstraction map. The detection of a conflict is further described with respect to FIG. 6 below.

In step 504, an alert is generated if a conflict was detected in the previous step. According to an embodiment, an alert is generated in the form of a message that describes the location, type, and project time of the projected conflict. The alert can also include other features such as severity and/or likelihood of occurrence.

In step 506, the generated alert is transmitted. According to an embodiment, one or more alerts can be transmitted to one or more destinations. For example, if a potential conflict is detected in the aircraft's currently projected route, alerts can be generated and transmitted to the aircraft, to the second vehicle in the projected conflict, and the command and control center. Each recipient can use the alert to take any actions that are appropriate. For example, an aircraft can take evasive action upon receiving an alert on a potential conflict, or the command and control center can reroute the aircraft and/or the second vehicle in the projected conflict. The transmission of the alert can be based on any known transmission facilities and technologies.

FIG. 6 illustrates a method 600 for detecting a conflict using the surface abstraction map, according to an embodiment of the present invention. In step 602, the projected routes of one or more vehicles are compared to detect any overlap. According to an embodiment, where the detection is for an incoming aircraft, for each of the projected routes of the aircraft, projected routes of other vehicles that can overlap any part of the aircraft's path can be compared.

The potential conflicts are of two types, referred to herein as (1) common runway conflicts, and (2) intersecting runway conflicts. The former refers to conflicts that can occur when the aircraft and at least one other vehicle are in a runway, taxiway or other travel path at the same time, and the latter refers to when they are in an intersection at the same time.

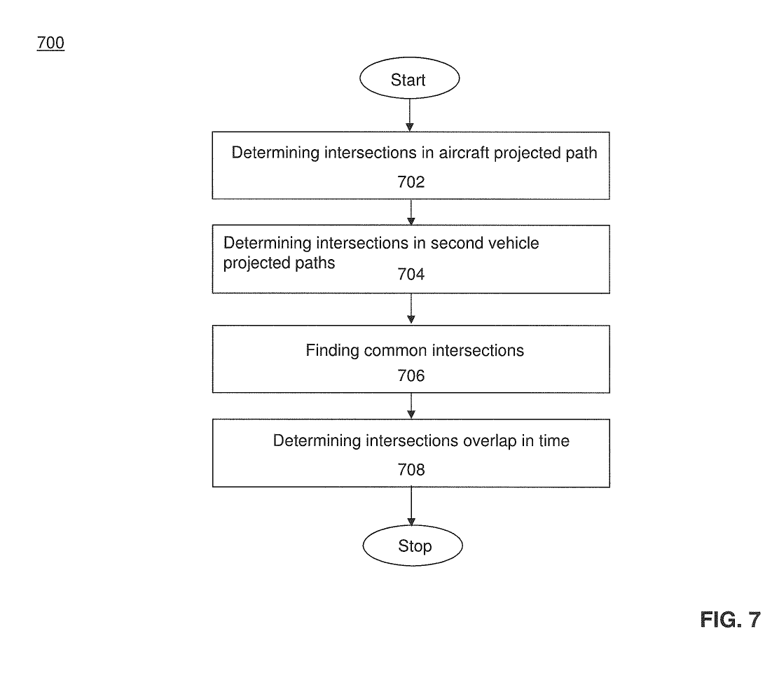

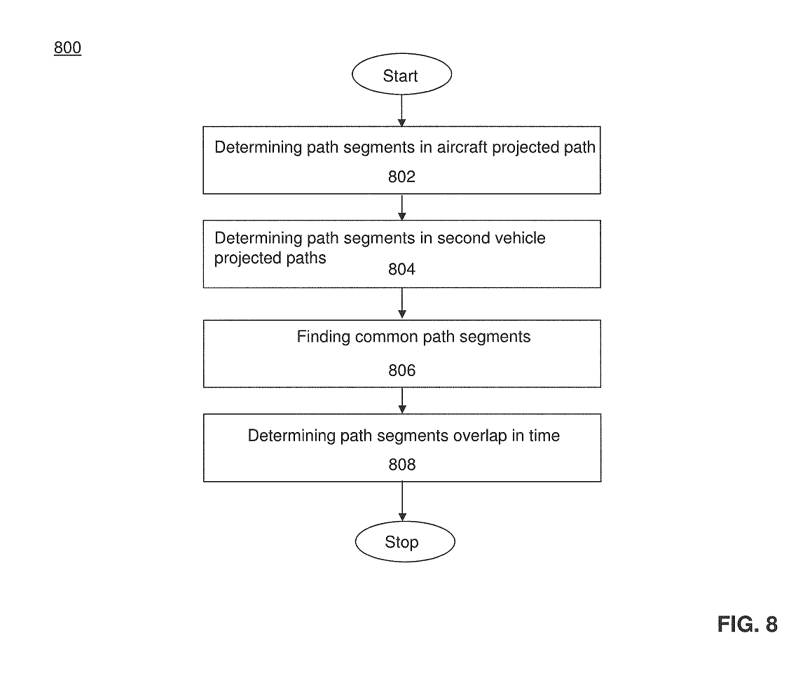

In step 604, a conflict is determined based on the comparison performed in the previous step. The determining of common runway conflicts is described further below in relation to FIG. 7, and the determining of intersecting runway conflicts are described further in relation to FIG. 8.

FIG. 700 illustrates a method 700 for determining common runway conflicts. As noted above, common runway conflicts occur when two or more vehicles simultaneously occupy the same runway and come within proximity to each other. Steps 702-708 are described below with respect to determining conflicts for an aircraft with one or more other vehicles.

In step 702, based upon the aircraft's projected routes, the line segments in the surface abstraction map that are part of the projected route of the aircraft are identified. According to an embodiment, the times of entry and exit for each of the line segment can be identified for the aircraft.

In step 704, projected paths of other vehicles (aircraft or other vehicles) are analyzed. For example, vehicles that are in motion and are in current locations that are within reachable distance from each of the line segments identified in the previous step can be identified and the corresponding projected routes can be determined.

In step 706, the projected routes of the aircraft and one or more second vehicles that overlap the aircraft's projected path can be identified. This step can involve the comparison of the projected routes of the aircraft and the projected routes of one or more other vehicles. The line segments in the surface abstraction map that are common to the projected routes of the aircraft and at least one of the second vehicles are determined in this step.

In step 708, the projected conflicts are determined in the common runways. For example, for each instance of the aircraft and one or more second vehicles being simultaneously in the same runway, it is determined whether they are sufficiently close to each other so as to cause a conflict. According to an embodiment, it is first determined whether the aircraft's time intervals between entry and exit to respective path segments that were found to be common in step 706 overlap with the corresponding entry and exit times of any second vehicle. Then, for each second vehicle that is projected to be simultaneously in the same runway as the aircraft, it is determined whether the second vehicle and the aircraft come within a predetermined threshold distance within each other. According to an embodiment, the determination of whether the vehicles approach each other within a threshold distance can be based on the respective entry times to that path segment and the movement of the respective vehicles. The threshold distances can be specified in one or more level, for example, to indicate that the closer projected encounters are of a greater severity than those that have a greater distance between the vehicles.

FIG. 8 illustrates a method 800 for determining intersecting runway conflicts. As noted above, intersecting runway conflicts occur when two or more vehicles simultaneously occupy an intersection. Steps 802-808 are described below with respect to determining conflicts for an aircraft with one or more other vehicles.

In step 802, based upon the aircraft's projected routes, intersections in the surface abstraction map that are part of the projected route of the aircraft are identified. According to an embodiment, the times of entry and exit for each of the line segment can be identified for the aircraft.

In step 804, projected paths of other vehicles (aircraft or other vehicles) are analyzed. For example, vehicles that are in motion and are in a current locations that are within reachable distance from each of the intersections identified in the previous step can be identified and the corresponding projected routes can be determined.

In step 806, the projected routes of the aircraft and one or more second vehicles that overlap the aircraft's projected path can be identified. This step can involve the comparison of the projected routes of the aircraft and the projected routes of one or more other vehicles. The intersections in the surface abstraction map that are common to the projected routes of the aircraft and at least one of the second vehicles are determined in this step. As noted above, intersections are represented as vertices in the surface abstraction map.

In step 808, the projected conflicts are determined in the intersections. For example, for each instance of the aircraft and one or more second vehicles having a common intersection in their respective paths, it is determined if they overlap in time in the intersection. According to an embodiment, it is first determined whether the aircraft's time intervals between entry and exit to respective intersections that were found to be common in step 706 overlap with the corresponding entry and exit times of any second vehicle. According to an embodiment, for each common intersection, an overlap in the entry and exit times of the aircraft and the second vehicle can trigger the generation of an alert. In other embodiments, entry and exit times can be further analyzed to determine the likelihood of a conflict, and an alert can be triggered only if there is a high likelihood of a conflict occurring in the intersection. For example, based on the actual size of intersections and the relative speeds of the vehicles, there can be instances in which the vehicles are simultaneously in the intersections without a conflict.

FIG. 9 graphically illustrates the analysis of vertices to determine intersecting runway conflicts. According to an embodiment, a list of vertices is created for each projected route. For example, the first vertex list 902 can be representative of the intersections in the projected route of the aircraft. The second vertex list 904 can be representative of the intersections in the projected route of a second vehicle. A comparison of lists 902 and 904 yield common intersections 908. Then, the entry and exit times for the aircraft and the second vehicle is determined with respect to each of the common intersections 908. For each common intersection, exemplary entry and exit times are graphically illustrated in 906. The time intervals for the aircraft and for the second vehicle are represented respectively using a dotted fill pattern and the a diagonal fill pattern. As shown in 906, a likely conflict is shown in 910 wherein the second vehicle enters the intersection before the aircraft has completely exited that intersection.

### Example System Embodiments

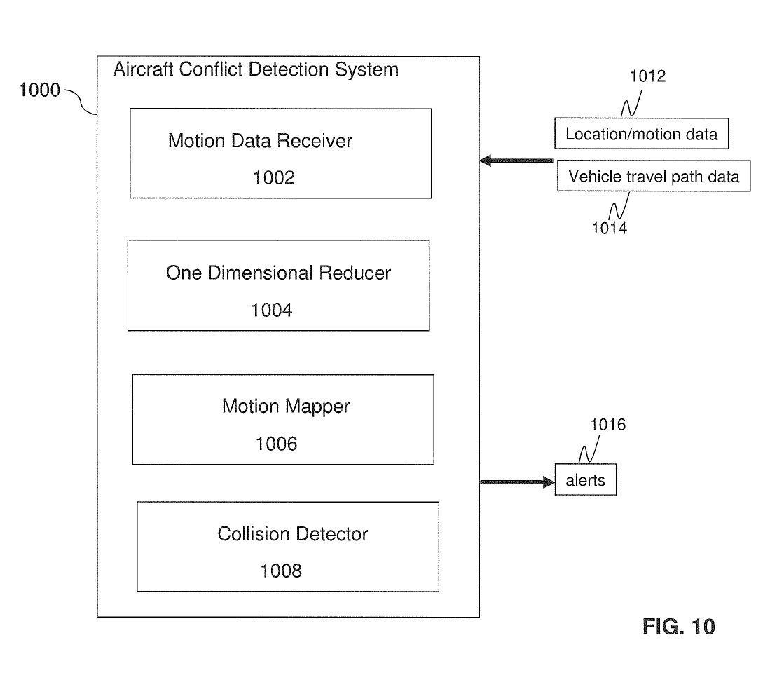

FIG. 10 illustrates an aircraft conflict detection system 1000, according to an embodiment of the present invention. For example, aircraft conflict detection system 1000 can perform method 100 described above to detect potential conflicts and generate alerts. Aircraft conflict detection system 1000 comprises a motion data receiver 1002, a one dimensional reducer module 1004, a motion mapper module 1006, and a conflict detector module 1008. One or more of the modules 1002-1008, may be implemented using a programming language, such as, for example, C, assembly, or Java. One or more of the modules 1002-1008 may also be implemented using hardware components, such as, for example, a field programmable gate array (FPGA) or a digital signal processor (DSP). Modules 1002-1008 may be co-located on a single platform, or on multiple interconnected platforms. For example, in one embodiment, all processing of the aircraft conflict detection system 1000 may be performed at one location, such as, for example, the command and control center or in an aircraft. In another embodiment, reducer module 1004 and portions of the mapping module 1006 can be implemented in a control tower or other location and transmitted to an aircraft that implements portions of the mapping module to map its location and the conflict detection module 1008 onboard.

Aircraft conflict detection system 1000 receives as input, but is not limited to, vehicle location and motion information 1012 and airport surface information 1014. In embodiments where system 1000 is deployed in an aircraft, for example, the received vehicle location and motion data can include data from the deployed-in aircraft as well as from second vehicles. As output, aircraft conflict detection system can transmit alerts 1016 to one or more destinations. As noted above, the transmitted alerts can lead to visual, audible, other sensory notifications to one or more entities. Also, according to some embodiments, the transmitted alerts can be used to formulate an automated response to initiate corrective action.

Motion data receiver module 1002 includes logic instructions to receive and analyze location and motion information from aircraft and other vehicles. Location and motion information can be received in real-time or in a non real-time. The received data can be analyzed and/or filtered to extract useful information in determining the location, motion information, and projected routes.

One dimensional reducer module 1004 includes logic instructions to reduce the three dimensional area of movement to a single dimension with respect to time. For example, one dimensional reducer module 1004 can generate the surface abstraction map described above. According to an embodiment, one dimensional reducer module 1004 can perform method 200, described above, to create the one dimensional representation of the three dimensional vehicle travel paths.

Motion mapper module 1006 includes logic instructions to map the motion and projected routes of aircraft and other vehicles from three dimensional space to a single dimension with respect to time. According to an embodiment, motion mapper module 1006 can perform method 400 to map the current location and projected routes of vehicles to the surface abstraction map.

Conflict detection module 1008 includes logic instructions to detect a conflict. According to an embodiment of the present invention, conflict detection module 1008 operates to determine common runway conflicts and intersecting runway conflicts as described above. In addition, according to an embodiment, conflict detection module 1008 can also include functionality to generate and transmit one or more alerts when a conflict is detected.

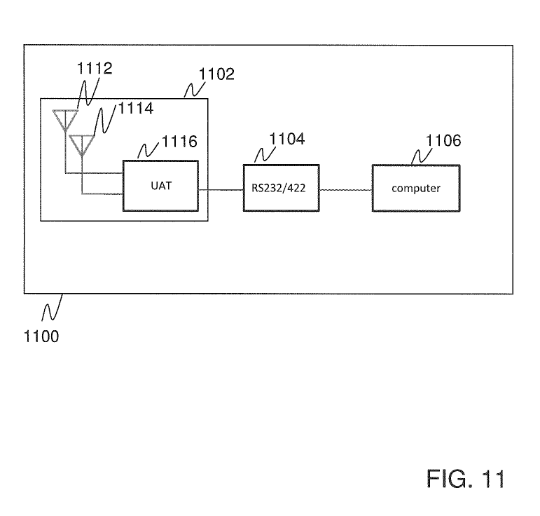

FIG. 11 illustrates an exemplary system 1100 comprising the aircraft conflict detection system 1000 described above. According to an embodiment, system 1100 comprises an antenna module 1102, a protocol conversion module 1104, and a computer 1106. According to an embodiment, antenna module 1102 can include one or more antennae, for example, a GPS antenna 1112 and a DME antenna 1114. GPS antenna 1112 can determine the monitoring vehicle's position where the system is deployed in, for example, an aircraft. DME antenna 1114 can be used to receive motion data of other aircraft and vehicles and airport surface data. A module 1116, such as a universal access transceiver (UAT), can be used to process and filter signals from the antenna before those are input to the rest of the system. Another module 1104 can interface between the antenna module 1102 and the computer 1106 to perform, for example, any required protocol conversions. For example, the antenna module can be connected to the computer using a RS232 or a RS432 protocol connector module. Computer 1106, for example, can include aircraft conflict detection system 1000.

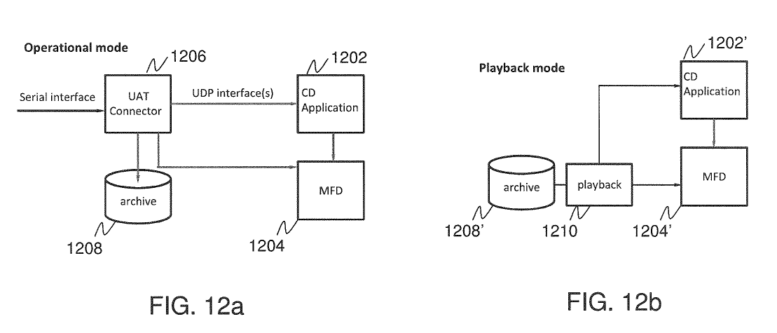

FIG. 12a illustrates further detail of computer 1106 configured to detect conflicts based on real-time information, according to an embodiment. Computer 1106 can include a conflict detection application 1202, such as, for example, aircraft conflict detection system 1000. Conflict detection application 1202 can provide its output to a display device 1204 capable of displaying and/or raising alerts. According to an embodiment, display device 1204 can be a multi function display (MFD) such as a cockpit display. Computer 1106 includes a data receiving module 1206 configured to receive data from antennae, such as, antennae 1112. Computer 1106 can also include a database 1208 to archive received vehicle location and motion data.

FIG. 12b illustrates an embodiment that is configured to be used for testing and/or training purposes. Modules 1202′, 1204′, 1208′ include the same functionality as modules 1202, 1204, and 1208, respectively. However, in the training mode, instead of receiving real-time information, the vehicle location and motion information can be played back from previously stored data by a playback module 1210. For example, by playing back vehicle location and motion information from database 1208′, playback module 1210 facilitates the training operation with little or no change to the rest of the system.

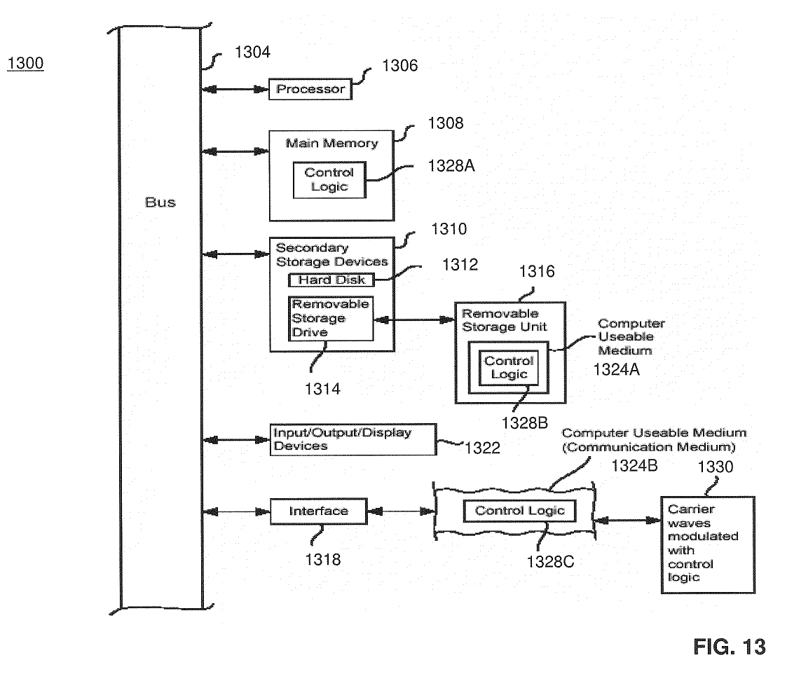

In another embodiment of the present invention, the system and components of embodiments of the present invention described herein are implemented using well known computers, such as computer 1300 shown in FIG. 13. For example, aircraft conflict detection system 1000 can be implemented using computer(s) 1300.

The computer 1300 includes one or more processors (also called central processing units, or CPUs), such as a processor 1306. The processor 1306 is connected to a communication bus 1304.

The computer 1302 also includes a main or primary memory 1308, such as random access memory (RAM). The primary memory 1308 has stored therein control logic 1328A (computer software), and data.

The computer 1302 may also include one or more secondary storage devices 1310. The secondary storage devices 1310 include, for example, a hard disk drive 1312 and/or a removable storage device or drive 1314, as well as other types of storage devices, such as memory cards and memory sticks. The removable storage drive 1314 represents a floppy disk drive, a magnetic tape drive, a compact disk drive, an optical storage device, tape backup, etc.

The removable storage drive 1314 interacts with a removable storage unit 1316. The removable storage unit 1316 includes a computer useable or readable storage medium 1324 having stored therein computer software 1328B (control logic) and/or data. Removable storage unit 1316 represents a floppy disk, magnetic tape, compact disk, DVD, optical storage disk, or any other computer data storage device. The removable storage drive 1314 reads from and/or writes to the removable storage unit 1316 in a well known manner.

The computer 1302 may also include input/output/display devices 1322, such as monitors, keyboards, pointing devices, etc.

The computer 1302 further includes at least one communication or network interface 1318. The communication or network interface 1318 enables the computer 1302 to communicate with remote devices. For example, the communication or network interface 1318 allows the computer 1302 to communicate over communication networks or mediums 1324B (representing a form of a computer useable or readable medium), such as LANs, WANs, the Internet, etc. The communication or network interface 1318 may interface with remote sites or networks via wired or wireless connections. The communication or network interface 1318 may also enable the computer 1302 to communicate with other devices on the same platform, using wired or wireless mechanisms.

Control logic 1328C may be transmitted to and from the computer 1302 via the communication medium 1324B. More particularly, the computer 1302 may receive and transmit carrier waves (electromagnetic signals) modulated with control logic 1330 via the communication medium 1324B.

Any apparatus or manufacture comprising a computer useable or readable medium having control logic (software) stored therein is referred to herein as a computer program product or program storage device. This includes, but is not limited to, the computer 1302, the main memory 1308, secondary storage devices 1310, the removable storage unit 1316 and the carrier waves modulated with control logic 1330. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for conflict detection of an aircraft, comprising:
reducing, using at least one processor, one or more vehicle travel paths in a three dimensional space to a first dimension;
receiving, using the at least one processor, data corresponding to a motion of the aircraft;
mapping, using the at least one processor, the motion to the one or more vehicle travel paths in the first dimension; and
transmitting, using the at least one processor, an alert if a potential conflict is determined based on the mapping in the one or more vehicle travel paths in the first dimension.

2. The method of claim 1, wherein the reducing comprises:
representing respective ones of the one or more vehicle travel paths with one or more line segments.

3. The method of claim 2, wherein the reducing further comprises:
combining the one or more line segments into a decision tree.

4. The method of claim 2, wherein each of the one or more line segments comprise a traveled length and two vertices.

5. The method of claim 2, wherein respective ones of the one or more line segments represent a centerline of a runway.

6. The method of claim 1, wherein the received data corresponds to real-time movements of the aircraft.

7. The method of claim 1, wherein the mapping comprises:
mapping a current location of the aircraft to the one or more line segments; and
mapping the motion to the one or more line segments.

8. The method of claim 7, wherein the mapping further comprises:
determining one or more projected routes of the aircraft; and
mapping the projected routes to the one or more line segments.

9. The method of claim 1, wherein the transmitting comprises:
detecting a conflict of the aircraft and at least one intruder vehicle;
generating the alert; and
sending the alert to one or more destinations.

10. The method of claim 9, wherein detecting a conflict comprises:
comparing at least one of a plurality of first vehicle travel paths with at least one of a plurality of second vehicle travel paths, wherein the first vehicle travel paths are projected travel paths of the aircraft in the first dimension, wherein the second vehicle travel paths are projected travel paths of one or more second vehicles in the first dimension, and wherein the first vehicle travel paths and the second vehicle travel paths are in a geographic area; and
determining the conflict when the aircraft and at least one of said second vehicles are within a predetermined distance threshold.

11. The method of claim 10, wherein the comparing comprises:
determining one or more first intersections in the set of first vehicle travel paths;
determining one or more second intersections in the set of second vehicle travel paths;
finding common intersections comprising of intersections common to first and second intersections; and
determining if the aircraft and at least one of said second vehicles are projected to be in one of the common intersections in a common time interval.

12. The method of claim 11, wherein the first and second intersections are represented as vertices in a decision tree.

13. The method of claim 10, wherein the comparing comprises:
determining one or more first path segments in the set of first vehicle travel paths;
determining one or more second path segments in the set of second vehicle travel paths;
finding common path segments comprising of path segments common to first and second path segments; and
determining if the aircraft and at least one of said second vehicles are projected to be in one of the common path segments in a common time interval.

14. The method of claim 13, wherein the comparing further comprises:
determining if the aircraft and the at least one of said second vehicles are projected to be within a protection zone.

15. A system to detect conflicts of an aircraft, comprising:
at least one processor;
at least one memory coupled to the processor;
an aircraft motion data receiving module configured to:
receive, using the at least one processor, data corresponding to a motion of the aircraft;
a one dimensional reducer module configured to:
reduce, using the at least one processor, one or more vehicle travel paths in a geographic area to a first dimension;
a vehicle motion mapper configured to:
map, using the at least one processor, the motion to the one or more vehicle travel paths in the first dimension; and
a conflict detector configured to:
transmit, using the at least one processor, an alert if a potential conflict is determined based on the map in the one or more vehicle travel paths in the first dimension.

16. The system of claim 15, wherein the one dimensional reducer module is further configured to:
represent respective ones of the one or more vehicle travel paths with one or more line segments; and
combine the one or more line segments into a decision tree.

17. The system of claim 15, wherein the aircraft motion data receiving module is further configured to receive the data in real-time.

18. The system of claim 15, wherein the conflict detector is further configured to:
detect a conflict of the aircraft and at least one intruder vehicle;
generate the alert; and
send the alert to one or more destinations.

19. The system of claim 18, wherein the conflict detector is further configured to:
compare at least one of a plurality of first vehicle travel paths with at least one of a plurality of second vehicle travel paths, wherein the first vehicle travel paths are projected travel paths of the aircraft in the first dimension, wherein the second vehicle travel paths are projected travel paths of one or more second vehicles in the first dimension, and wherein the first vehicle travel paths and the second vehicle travel paths are in the geographic area; and
determine the conflict when the aircraft and at least one of said second vehicles are within a predetermined distance threshold.

20. A computer readable media storing instructions wherein said instructions when executed are adapted to detect a conflict of an aircraft with a method comprising:
reducing, using at least one processor, one or more vehicle travel paths in a geographic area to a first dimension;
receiving, using the at least one processor, data corresponding to a motion of the aircraft;
mapping, using the at least one processor, the motion to the one or more vehicle travel paths in the first dimension; and
transmitting, using the at least one processor, an alert if a potential conflict is determined based on the mapping in the one or more vehicle travel paths in the first dimension.
